(19) United States
(12) Patent Application Publication
(10) Pub. No.: US 2019/0105556 A1
(43) Pub. Date: Apr. 11, 2019

(54) Family Game with Braille

(71) Applicant: Polly Blazakis, Tampa Bay, FL (US)

(72) Inventor: Polly Blazakis, Tampa Bay, FL (US)

(21) Appl. No.: 15/728,317

(22) Filed: Oct. 9, 2017

(51) Int. Cl. A63F 9/00; G09B 21/00; A63F 11/00; A63F 3/04; A63F 3/00; A63F 1/04

(52) U.S. Cl. CPC A63F 9/0001; G09B 21/003; A63F 11/0011; A63F 3/0434; A63F 2011/0062; A63F 1/04; A63F 2001/0408; A63F 2001/0441; A63F 2009/0004; A63F 3/00895

(57) ABSTRACT

The current invention is a family board gaming for everyone with Braille. The game involves obscura roadside oddities. It will allow users to take a road trip across the United States to visit all of the strange Roadside Oddities. The Game comes with two sided color cards with braille embossed cards on the reverse card side. Braille embossed on key points of the board itself including braille instructions and dice. The modest sized tactile card holders keep the playing area organized for easy play. They would come in variety of Oddity replicas ranging from an oversized Pistachio Nut, the World's Largest toilet and more. The game will come with Braille Die and Braille on the playing board.

### CROSS-REFERENCES TO RELATED APPLICATIONS (IF ANY)

None.

### BACKGROUND

### 1. Field of the Invention

This invention relates to a family game and particularly ones that has braille.

### 2. Description of Prior Art

There are a limited number of family games that family member can play with other family members who are visually impaired. This can create a situation where the visually impaired family member feels left out.

There is still room for improvement in the art.

### SUMMARY OF THE INVENTION

The current invention is a family board gaming for everyone with Braille. The game involves roadside oddities and obscura roadside oddities. It will allow users to take a road trip across the United States to visit all of the strange Roadside Oddities. Every adventurous road trip would be amazingly fun and different each time.

The players will read aloud the Wacky, Odd, Creepy and downright Strange roadside Oddity they choose in their adventure. There are 120 Wacky oddities within the game. As they attempt to collect and tally their mileage to reach their destination they may hit Pit falls. The game has stops and delays. Anything from a Potty Break, Car sick and even a random Roadkill animal can put a bump in their adventure.

The game comes with two sided color cards with braille embossed cards on the reverse card side. Braille embossed on key points of the board itself including braille instructions and dice. The modest sized tactile card holders keep the playing area organized for easy play. They come in variety of Oddity replicas ranging from an oversized Pistachio Nut, the World's Largest toilet and more.

### BRIEF DESCRIPTION OF THE DRAWINGS

Without restricting the full scope of this invention, the preferred form of this invention is illustrated in the following drawings:

FIG. 1 shows the game board;

FIG. 2 shows the die used in the game;

FIG. 3 shows sample cards holders for the game;

FIG. 4 shows a sample delay card;

FIG. 5 displays another sample delay card;

FIG. 6 shows a mileage card;

FIG. 7 shows an oddity card; and

FIG. 8 shows another oddity card.

### DESCRIPTION OF THE PREFERRED EMBODIMENT

The current invention is a family board gaming for everyone with Braille. The game involves obscura roadside oddities. It will allow users to take a road trip across the United States to visit all of the strange Roadside Oddities. Every adventurous road trip would be amazingly fun and different each time.

The game would be for multiple players, two to four in the preferred embodiment.

The game comes with two sided color cards with braille embossed cards on the reverse card side. Braille embossed on key points of the board itself including braille instructions and dice. The modest sized tactile card holders keep the playing area organized for easy play. They come in variety of Oddity replicas ranging from an oversized Pistachio Nut, the World's Largest toilet and more.

The game has a game board 10 with picture graphics. Each color location represents a vacation destination. There are winding roads, trees, valleys, highways, traffic jams images covering and winding around everything. In the preferred embodiment, the game board 10 is tactile with Braille labels as well as fancy graphics for the sited. Specific locations like Sea World have a texture to the location that may feel slick. The Football of Fame texture would be that of football leather. The Grand Canyon may feel like gravel and so on.

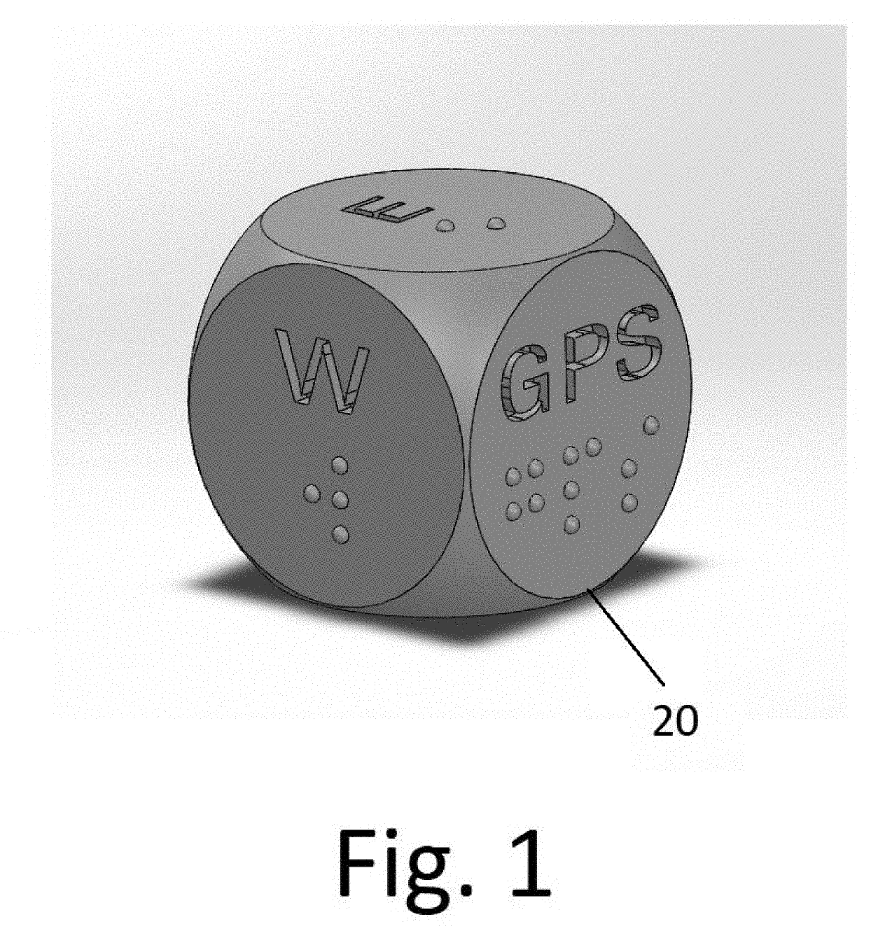

As shown in FIG. 1, the game will have unique dice 20. The dice 20 will have the following sides, E(×2) W(×2) and GPS(×2) (6 side's die). Besides stating E, W, GPS they will also be printed in braille on their corresponding sides.

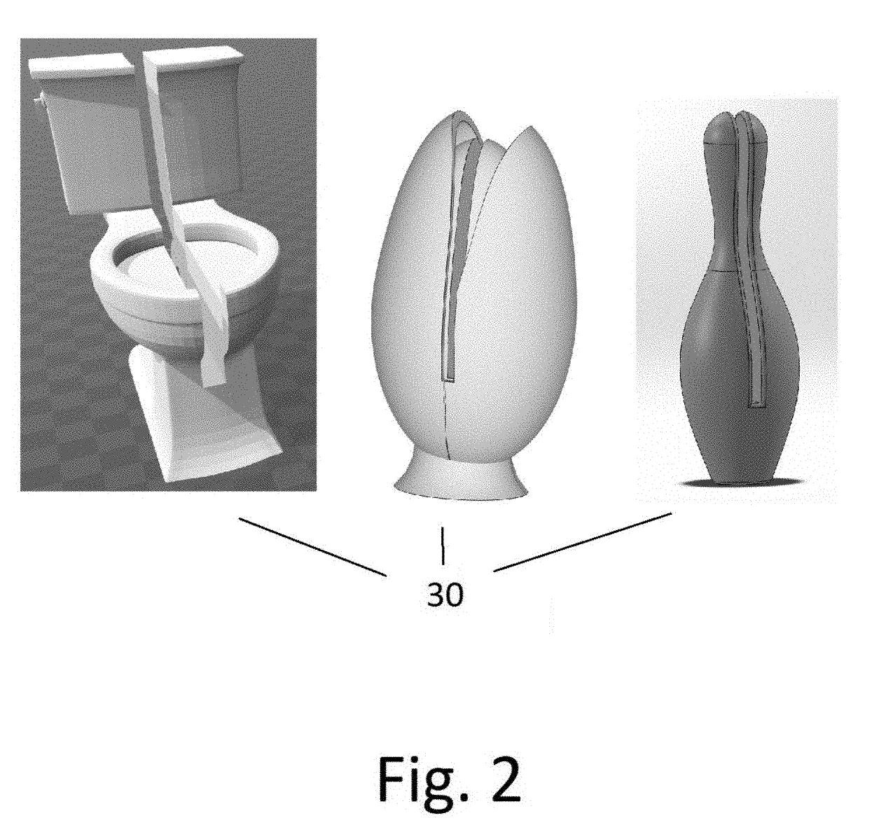

The game will have card holders 30 that represents each player. The card holders 30 each will be different and can be used to hold the players cards. Sample card holders 30 are shown in FIG. 2. These are a pistachio nut, bowling pin, Cowboy boot and toilet in the preferred embodiment. The card holders 30 will hold an oddity card. The oddity card holders 30 are one for each player to keep their cards organized and easier for the blind. Every card holder 30 is plastic and can fit in a player's hand this is tactile so the blind can actually feel their vehicle of choice, besides being visually appealing for the child or teen.

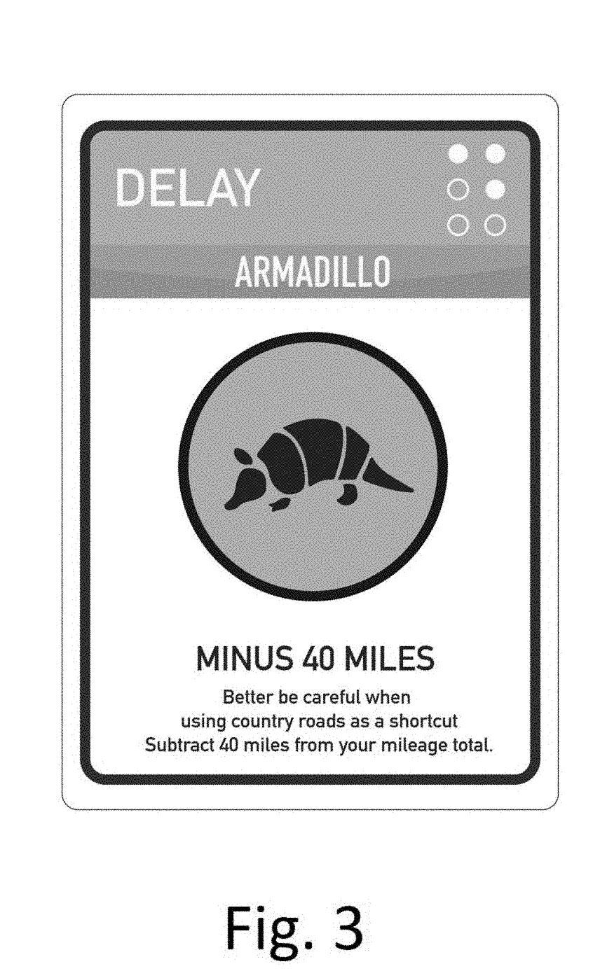

The game has several different types of cards as shown in FIGS. 3 through 7. Every playing card had a photo word side, with opposite side having Braille table statement of the card.

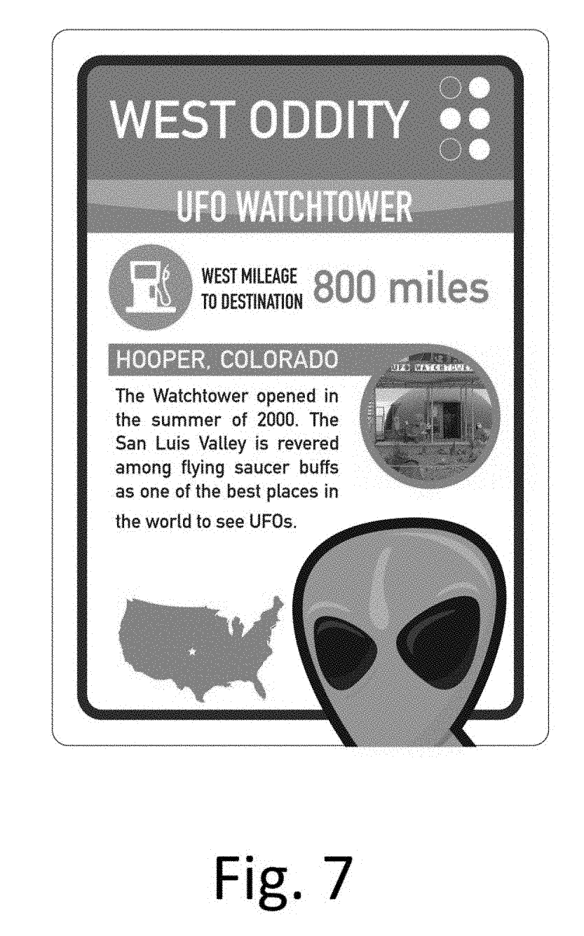

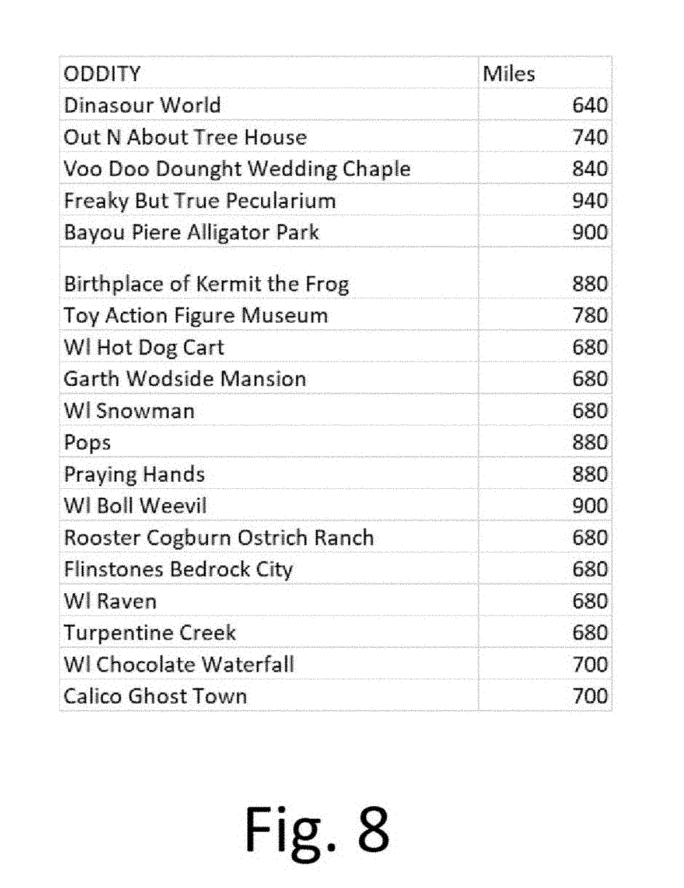

To play the game, each player rolls the E/W/GPS die pending which side they roll will direct them which Oddity Stack they will choose from. If they roll a E they will pick an Oddity from the East Oddity stack pile of cards. If they roll a W they will pick an Oddity from the West Oddity stack pile of cards. If they roll a GPS this will allow that player to Choose E or W Oddity stack pile of cards to select a Oddity. As sample of these cards are shown in FIGS. 7 and 8. A sample of the distances associated with these cards are shown in FIG. 8.

Each player rolls the dice and the first player to roll the word GPS gets to go first the order of the players will follow by the farthest mileage destination vacation spot to the shortest mileage last.

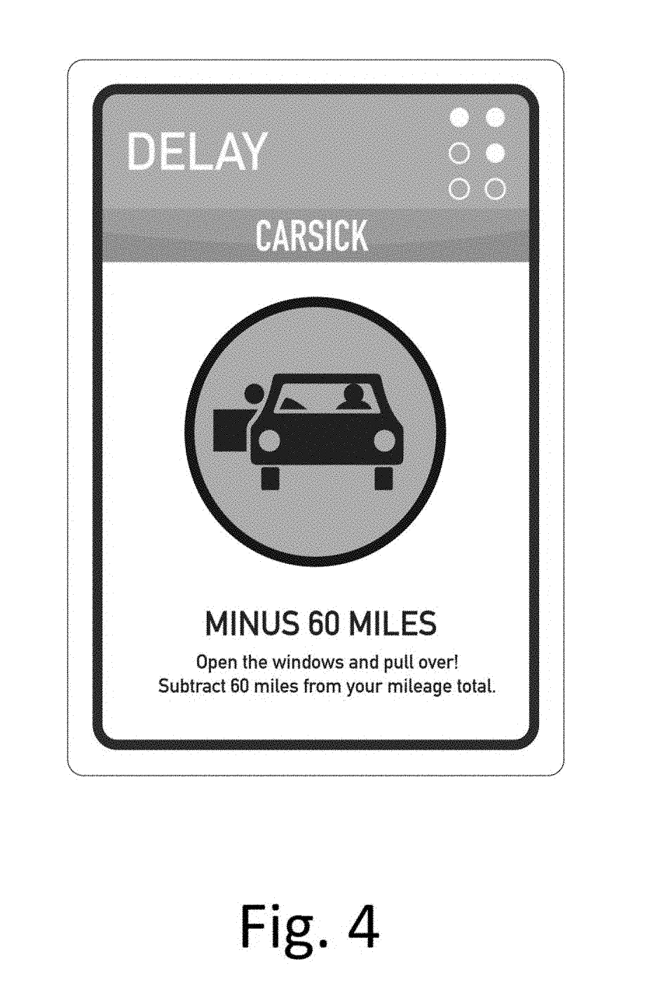

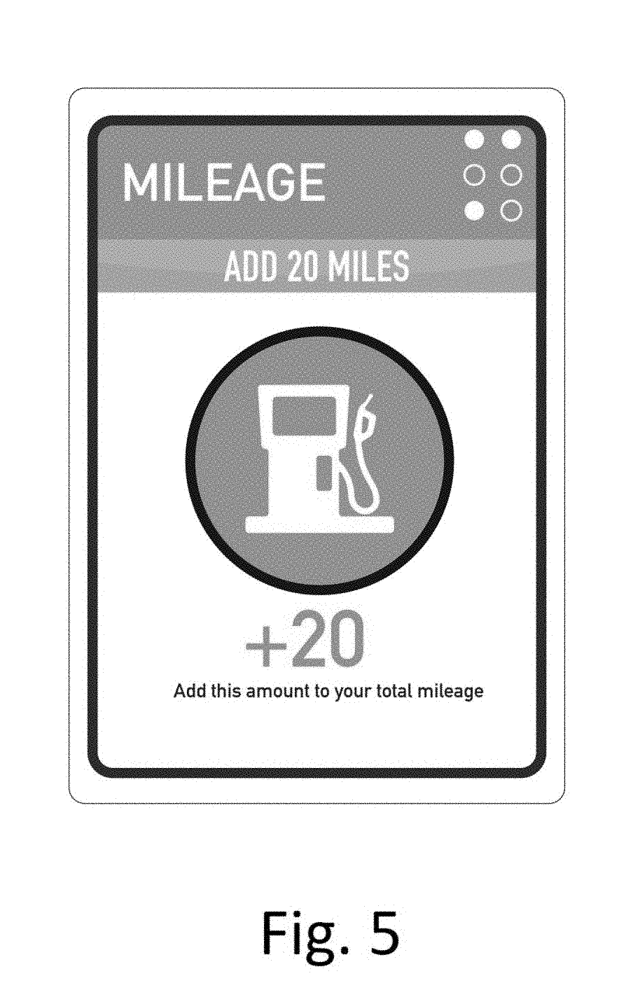

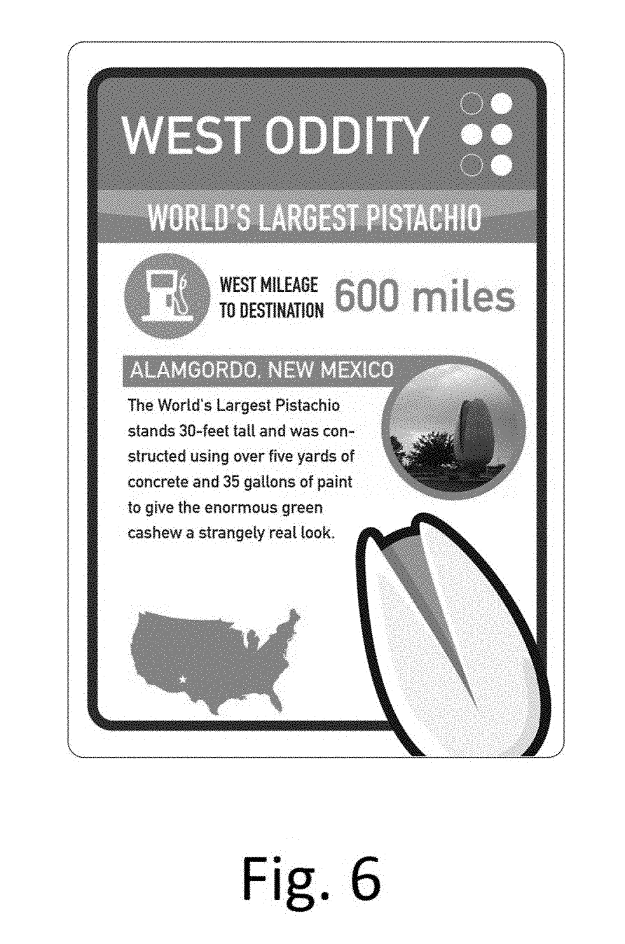

The game would have a central stack of cards that the players take turns pulling from one by one. The cards consist of distance mileage cards, as shown in FIGS. 5 and 6 and travel trip cards, as shown in FIGS. 3 and 4.

The distance cards have distances that are used to add up mileage up to get to the player's destination vacation point first.

The travel trip cards can serve to delay the vacation, that will stop a player and force them to sit out a turn or a card that a player can place on any other player to delay them if they are too far ahead. Some of these cards are: Car Sick pull over, Caught littering ticket, flat tire, Potty Break, Hail Storm, Blizzard, Road Kill, Hotel 2 nights, Speed Trap, GPS malfunction and so on.

Players tally their mileage to get to their destination point. As they each “roll in” 1st 2nd 3rd 4th each will be given mileage points based on their roll in position. The 1st will obtain 10 miles they each will get additional mileage based on increments of 10 miles per position roll in 2nd will obtain 20 miles and so on. They will take their mileage of their tally which will be on or over their mileage on the oddity card. They will take which ever mileage is greater the tally or the oddity and subtract. Lastly, they will add in their given obtained mileage of roll in position and add that to that number to get their final mileage number. The player with closest number on or to their oddity is the winner.

In the preferred embodiment, there is a minimum 120 Oddities cards that may be used in the game each with its own distance. These are broken down by geographical region like a state. A sample of some of these oddities cards are as follows:

Alabama—WL Boll Weevil—the world's first monument built to honor an agricultural pest The Boll Weevil Beetle has been hailed as the insect brought prosperity to the failing farming agricultural economy.

Arizona—Rooster Cogburn Ostrich Ranch—take a tour around the world all in one place. Ostrich and goats from Africa, donkeys from the Mediterranean, Deer from Europe, Miniature Goats from Nigeria, Ducks from China, Lorikeets from Australia, and Redneck Owners from Oklahoma.

Flintstones Bedrock City—this 30 acre barren post-apocalyptic landscape is the ideal location for the Famous Bedrock Flintstones Family. Park pay & have a afternoon of photo taking with your favorite caveman family over 3000 pounds of chocolate, authentic copper candy kettles where The chocolate gushes out of the fountain head, cascades down the kettles, then settles in the swirling chocolate pool.

Alaska—WL Chocolate Waterfall—over 3000 pounds of chocolate, authentic copper candy kettles where the chocolate gushes out of the fountain head, cascades down the kettles, then settles in the swirling chocolate pool.

Arkansas—Turpentine Creek—Love Cats? Lions tigers cougars & leopards visit stay overnight in one of 5 tree houses this 459 acre wildlife refuge one of the worlds largest public rescues abused wild cats from around the world.

WL Raven—in the small town of Ravenden population aprox. 500 people stands the town mascot a 12 foot black Raven.

Colorado—Calico Ghost Town—Old West throwback experience, saloons, lawbreaker roundups, evening ghost tours & gun fights nearly 5000 gold mine sites, Stay a night or the weekend at the camp ground.

Connecticut—Zaffis Museum of Paranormal—The intriguing personal collection of a professional demon-chaser. The items are supposedly “cleansed” before joining his collection. John Zaffis also hosts a show called “Haunted Collector.”

PT Barnum Museum—Known as the Father of Circus to some, this building was designed by Barnum himself as an institute for science and history, years later that it became a museum dedicated to his life and the circus.

Winivan Farm—upscale hotel 18 cottages, tree house, beaver lodge, maritime Cottage, Lighthouse, Helicopter Room & more.

California—Winchester Mystery House—over 500 rooms with miles of twisting hallways and secret passageways in the walls this never ending house was built to appease the dead spirits whom died from the Famous Winchester Riffle.

WL Donut—The home of Randy's Donut Shop this 24 hour drive thru sits under a 23 foot doughnut.

Delaware—Natural History Museum—Home of WL Dung Beetle GIANT POOP ball, exhibits from the rain forest, stone age and more.

Victrola Museum—World's largest collection of Victrola & Victrola Dogs AKA talking Machine of 1901.

Florida—WL Bowling Pin—Splittsville Resides the tallest Bowling pin ever.

Jules Undersea Lodge—In a lagoon at Key Largo Undersea Park, Jules' is the world's only underwater hotel. Scuba diving is a must to stay in this Underwater hotel with full amenities, sleep with the fishes

Spiritual Community—the unofficial psychic capital of the world because there are so many psychics who reside there.

Georgia—Vardzia Cave Monastery—underground monastery fortress a medieval kingdom from the 1100's smack dab in middle of Georgia.

Illinois—WL Abraham Lincoln Statue—the 16th President of the United States and a Giant among men, not only for his stature but his historical accomplishments as one of the most important US Presidents in the History of the US. This statue depicts Abe at a fanciful 72 feet tall.

WL Laundromat—Not your average laundry mat, Wednesdays dine in while you get your laundry cleaned. Special events, fireworks and more, Its always a surprise when you launder at The World's largest Laundromat.

Iowa—WL Truck Stop—Iowa 80 Truckstop is like a small city, others have likened it to a Trucker's Disneyland, all can agree it is a place not to be missed.

Idaho—The Dog Bark Park Inn—offbeat experience of sleeping inside a Giant Dog. A Giant Beagle measuring 30′ high. Guest rooms have dog themes.

Idaho Potato Museum—off I-15 Potato Museum with WL Pringles Can, Everything potato you can imagine one of the TOP 50 Potato sites in the World.

Indiana—Blue Springs Caverns—Cavern Boat Tours & Sleep in Limestone Caves. Darkness 24/7 fish living in the caverns evolved to blindness.

Fanta Suites—Pure Fantasy, Stay in the Space Odyssey, Caesers court, Geisha Gardens, Pink Cadillac, Sherwood Forest, Wild West, James Bond & more.

Kansas—Geographic Center of the USA—it is exactly as it reads. This spot is the geographic center of the entire country—that means all of our wonderful states.

WL Prairie Dog—Oakley Kansas might have to argue with Phillip SD over who's Prairie Dog is the biggest both stake the claim to this title. Cute Little underground buggers!

Kentucky—Ark Encounter—Interactive Museum attraction Park, it features a full-size Noah's Ark, built according to the dimensions given in the Bible. Spanning 510 feet long, 85 feet wide, and 51 feet high, this modern engineering marvel amazes visitors young and old.

Cave City—Dinosaur World—T-Rex, Pterodactyl, And Velociraptor's hang out with More than 100 dinosaurs that roam these woods.

Louisiana—Bayou Pierre Alligator park—Gators, Gators, Gators Farm, food, fun and drink. Gator Wrestling, gator toys, photo booth and more.

Montana—Triple Creek Ranch—Wake up your inner Cowboy, Go on a Cattle Drive, Sleep in a cabin have the entire LIVE COWBOY Experience.

Mississippi—Birthplace of Kermit the Frog—“it isn't easy being green” The Muppet Museum and the roots of Jim Henson's most famous GREEN creation.

Missouri—WL Hotdog Cart—Winner of the title from Guinness World Records 2016 This 9 Feet 3 inch wide, 23 Feet 2 inch long, 12 Feet 2.75 inch High, this is defiantly a oddity to see.

Garth Woodside Mansion—Historic hotel looks like a haunted mansion from am movie but insides its Victorian deco rooms are a thing of beauty. This spot is also where the Famous Mark twain loved to hide out to relax.

Minnesota—WL Snowman—weighing in at 40 Tons This snowman will not melt. Built in 1972 and the beloved mascot of North St Paul, this massive happy fellow has a smile 16 feet wide.

WL Jolly Green Giant—Don't tell this guy you don't like broccoli. Standing 55 Feet tall and the most brilliant shade of Green he is visible from I-90.

Massachusetts—The Paper House—What would you do with all your newspapers, probably not save them to build a paper house. But in 1922 what began as a hobby became much more. The paper house even has a paper piano.

The Witch House of Salem—Bubble Bubble Toil and Trouble The horrific history of the Salem Witchcraft Trials this 1692 structure is the only building with direct ties to the historical WITCH HUNT History

Museum of Bad Art—this art is so bad its good. Over 400 pieces to the permanent collection.

Singing Beach—Did you know that beaches can sing. It does in Manchester. The Friction between the grains of sand caused a curious singing sound.

Maryland—Edgar Allen Poe's Grave—1809-1849 a mysterious death The Famous Gothic Author known for “The Raven” and many more dark & dreary tales rests in Baltimore with a Granite Headstone etched Raven on its front.

Enchanted Forest Theme Park—remnants of a storybook amusement park behind a strip mall, abandoned and spooky.

Urology Museum—fascinating museum dedicated to the history of Urology. See their historical creepy collection of bladder stones, things that should Not be inside your body. Can you say CREEPY.

Maine—International Cryptozoology Museum—Only one in the World Museum of Cryptid specimens. Cryptozoology:pseudoscience the search for existence of creatures like BIGFOOT & Neisse.

Umbrella Cover Museum—take the ferry out to Peaks Island. Just past the General Store.

Sardine history Museum—This non-profit historical account of sardines is only open from the third Sunday in June through September 30th.

Michigan—Tomb Fedor Protar—1837-1925 folklore tales that Protar a Czarist Noble that escaped Old World Russia and escaped to Beaver Isalnd. He is the only Known “Czar” to be entombed.

Ann Arbor's Fairy Doors—Whimsical portal to another world. Urban Fairies live in this Ann Arbor Home a hidden 6″ door that leads to a fairy world behind the home walls.

Henry FORD Museum—A vast collection of documented artifacts that celebrate the human genius. From race cars to futuristic homes to Things that you can't explain or even imagine. On multiple acres this venue can easily be all adventure.

North Carolina—Henry River Mill village—abandoned village that doubled as The Hunger Games' post-apocalyptic wasteland, remnants of mining towns from the Gold Rush.

Devils Tramping Ground—a large circle on the ground, barren of plant life, about 15 feet wide. According to stories dating back to 1882, the devil comes to dance and nothing grows on the ground ever since.

North Dakota—Enchanted Highway Sculptures—a 32 mile stretch off I-94 one man builds amazing sculptures. A total of 7 Current to date 5 times car size—grasshopper, geese, deer and farm family.

Ronald Regan Minuteman Missile Site—Leftover from the COLDWAR launch site the launch room, launch button have been preserved for historical posterity and tourists.

New Mexico—Kokopelli's Cave B&B—sleep in the 1700 sq. foot rock cave dwelling 70 feet beneath the grounds surface, waterfall shower & more underground temperatures range from 68-73 degrees.

New Jersey—World's Largest Elephant “LUCY”—built in 1881 Lucy stand 65 feet high 60 feet long 18 feet wide weighing nearly 90 tons she is her own small museum to her history.

Monument to “War of the Worlds”—8 feet tall bronze monument to the radio version “War of the Worlds” written by H. G Wells, in 1938 before TV, the radio was Family entertainment Live radio shows were so that public believed it was a live invasion news report even the local authorities were in fear.

Nebraska—Carhenge—Replica of Stonehenge but this art structure is actually constructed from 38 full size car's from the 1950'S & 1960's.

New Hampshire—Libby Museum—this museum over 100 years old houses bizarre collection of taxidermy, native American artifacts, mummy hands and more.

Lake Winnioesaikee Mystery Stone—in 1872 a man digging a fence post found a odd carved egg shaped stone that is too perfect & precise to been carved in 1872 or prior to that date.

Bensons Park—Do you like the Zoo? This old zoo now turned into a public park lets visitors act like the animal. Hang out in the old animal cages and let your inner animal out.

New York—Evolution nature Store—Home of the Giant Articulated Sloth Collection, this store has some of the strangest fossils, framed insects, tribal skulls.

Ghostbusters Fire House—Hook & Ladder #8 fully functional, the location of the Original Ghostbusters film.

Nevada—Area 51—The MOST SECRET desolate military facility in the WORLD, rumored/fact to hold UFO Alien Crafts/DNA, ET technologies. Monitored 24/7 by secret surveillance underground as well as above. Caution Warning signs posted enter at risk of DEATH Private Government Property.

Clown Motel—Thousands of Clown's with every turn this off beaten path motel also is next to a Wild West Grave yard where its haunted ghosts are known to have checked in with guests.

The Black Mailbox—No one knows who it really belongs to. For every weird story about this mailbox there are 1000 more. The landmark is an essential stop for Nevada UFO road trippers

Ohio—WL Crystal Ball—A 700-pound was once at the Ross C. Purdy Museum of Ceramics. It was removed from public viewing in 2010 due to too many travelers wanting to see it. Or perhaps see their future.

WL Basket Building—home office of Longaberger Co. this 9,000 ton basket building stands 7 story high the glass ceiling allows people to see the handles from inside.

Mill Creek Park Witches Cave—A beautiful serene park. Take a walk into the past into the winding woods of cavernous rocks. The Local folklore of the deep wide crack into a stone cavern.

Oregon—Out-n-About Tree house Treesort—“Treezeebo” & “Yurtree” are just 2 of 18 luxury tree house areal homes, move around by a swinging sky bridge, zip lines and more for a woodland adventure.

Freaky But True Pecularium—The word Peculiar in Pecularium fits this place to the T. An Emporium/Shoppe full of the down right bizarre, unique, odd, creepy, strange, rare, gross & odd.

Voo Doo Donght & Wedding Chapel—Where else can you get married and eat a donuts and yes at the same time. Their Original baked goods have names like Voodoo, Cat Daddy. They are so delicious you might think they put a spell on you. You can't eat just one.

Oklahoma Toy Action Figure Museum—the worlds only museum dedicated to the art of collecting action figures. Over 13000 separate figures in mint condition original packaging.

Pops—Home of the 66 foot tall neon pop bottle this restaurant serves over 700 different types of pop arranged by color.

Praying Hands—made of 30 tons this bronze devotional of praying hands points to the Heavens High check them out on the web.

Pennsylvania—The Shoe House—“there was a old lady that lived in a shoe” TRUE this Shoe even has its own address 197 Shoe House Road, Now open for tours this was once a actual livable shoe home back in 1948.

Mutter Museum—Museum of Medical Oddities, Einstein's Brain, Foreign Body Collection, conjoined twin skeletons some of the craziest things from history past.

Rhode Island—Fantastic Umbrella Factory—it's not about umbrellas this 250 year old farm features a mini petting zoo, stained glass wares, odd sculptures, ice cream Shoppe and a hippy-bazaar.

South Carolina—Button Museum—As result of insomnia unable to sleep one man's hobby of collecting buttons and craftiness has become a Museum. Need a button, loose a button, buy a button? There is even a outhouse covered in buttons.

Walterboro Water tower—this once icon in the city of Waterboro besides being the city's water supply also housed lawbreakers. The water tower was also the jail with 6 small cells.

South Dakota—Depression Era Dinosaur Park—for over 70 years these dinos have drawn the crowd despite the Brontosaurus & Diplodocus with the wrong head attached. The Goofy eyed mismatched prehistoric creatures are popular with the 12 & under crowd despite the Jurassic giants paleontology inaccuracies.

Devils Gulch—the site of infamous Jesse James's greatest escape. Chased with no where else to run cornered with 18 feet of rock & air & a 60 foot drop James took the plunge and made it.

Texas—The Museum of Weird—This Weird Museum hides in the back of the “LUCKY LIZARD” store things like the Cyclops pig, two headed chickens, shrunken heads, full sized Frankenstein and other classic movie monster. The Lucky Lizard salvaged and continues to carry out tradition of old school freak show dime store museum.

Cadillac Ranch—10 Cadillac's carefully constructed and partially buried in the ground like carrots systematically sprouting from the earth These Pink Graffiti Cars are a wondrous site (not a ranch but a public art installation and sculpture in Amarillo, Tex.).

Munster Mansion—exact replica to the 1960's hit Tv show The Munsters Vampires and Frankenstein live happily married.

Tennessee—Silky O'Sullivans—This 100 year old pub will leave a impression. Experience dueling pianos, while surrounded by goat pen in its outdoor seating area. The goats love to guzzle beer.

Salt & Pepper Shaker Museum—its exactly what it sounds like but with over 20,000 sets of shakers the collection from 25+ years of collecting.

Lost Sea Adventure—Americas largest Underground lake a huge underground cave system that gives tours in flat bottom boats.

Utah—Museum of Ancient Life—WL collection of dinosaur specimens in the world also has a IMAX 3D theater a working paleontological laboratory where visitors can actually watch science at work.

Vermont—Knights Spider Web Farm—“The Itsy Bitsy Spider crawled up the water spout”, this farm is the only spider web farm The Orb Spider spins amazing webs and there is a abundance of Orb Spiders at this Farm the spiders webs are preserved and spray painted for better visibility over 16,000 webs have been collected and displayed.

Ben & Jerry's Flavor Graveyard—RIP dead un-liked ice-cream flavors the final resting place where each unpopular flavor has a proper quirky headstone in their Waterbury cemetery.

Dog Chapel—“Welcome all creeds, All Breeds, No Dogmas allowed” this small dog chapel built on “Dog Mountain” to celebrate the special bond and spiritual connection between dogs and people.

Virginia—Presidential Pet Museum—As odd as it sounds there is a Museum to the history for every past presidential pet in the US history of the White house. Visit the exhibit to their beloved pets there is more to it than just cats and dogs. Past presidents have had horse, donkey, pygmy hippo, goose, snakes, bobcat, wallabies.

Route 11 Potato Chip Factory—Home of the infamous Chesapeake Crab Chips. This factory cooks and bags 13 varieties of its chips by hand

W. Virginia—Trans Allegheny Lunatic Museum—Now Abandoned this creepy asylum was in operation from 1864-1994. It is closed permanently but Ghost tour groups hold nightly ghost investigations of the poor souls that were left behind.

Mothman Museum—Historic popular legend which also had a factual base makes the Mothman more mystery than ever. This strange humanoid creature said to have glowing red eyes

Wyoming—Bighorn Medicine Wheel—a mysterious pattern of stones believed to be Native American holds powers to predict astronomical events, these sacred “medicine wheels” are not limited to Wyoming they exist thought North America although this one is the largest of all of the wheels.

Population ONE—smallest town in the USA population one person where the green sign stated Buford POP 1 ELEV 8000′.

Washington—WL Egg—this 12 feet long 1,200 pound egg replica sits atop a 10 foot steal pedestal. Off Of highway 505 you can't miss it painted like a Giant American Flag the egg doubles as a 9/11 memorial for the townspeople.

WL Milk Bottle #1—built in 1934 38 feet tall 15 feet wide, this giant milk bottle with building attached was once part of Benewah Dairy Co. Over the years it was a junk shop, a diner. It is the remaining functional one of seven that were built by the Dairy Co.

WL Penny—The world's largest Penny originally was a school project where school children would save their pennies so the local town could build a Hospital in 1953. To the locals it was called “The Angel on Snowshoes”. The Copper colored monument represents 1.7 million pennies saved.

The game can use of a QR code, and an interactive Website app that can be used in conjunction to the visually impaired. This QR code/web site will offer VERBAL instructions for the visually impaired.

Advantages

The current invention encourages personal connections. It has educational benefits for friends and family of the visually impaired. The players can learn braille, learning unique oddities throughout a geographical region such as the U.S., experiencing the challenges of visual impairment, and mathematics. It is a simple, FUN game that includes learning math skills by counting, and reading practice skills as well though young players can play with limited reading skills due to the photo graphics.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A game comprising:
Having a game board, dice, oddity cards, distance cards, and travel cards where each player gets an oddity card where the oddity card has an oddity location with set mileage on it, where the distance cards and travel cards are place in a pile and the player take turns drawing from the pile where the distance cards have distances that can be used to add up to the distance on their oddity card and the travel cards have effects that can effect a player and layers tally their mileage to get to their destination point where the player with closest number on or to their oddity location is the winner.

2. A game according to claim 1 further comprising:
Having the card be two sided with one side have braille.

3. A game according to claim 1 further comprising:
Where the dice will have the following sides, two sides E, two sides W and two sides GPS.

4. A game according to claim 3 further comprising:
Where the dice will also be printed in braille.

5. A game according to claim 1 further comprising:
Having a plurality of card holders.

6. A game according to claim 5 further comprising:
Where the card holder would hold the oddity card.

7. A game according to claim 1 further comprising:
Where the game board tactile with Braille labels.

8. A game according to claim 7 further comprising:
Where the game board has specific locations and where the locations would have a texture to match that location.

9. A game according to claim 1 further comprising:
Having each player roll the and depending which side they roll will direct them which Oddity Stack they will choose from, if they roll a E they will pick an Oddity from the East Oddity stack pile of cards, if they roll a W they will pick an Oddity from the West Oddity stack pile of cards, if they roll a GPS this will allow that player to Choose E or W Oddity stack pile of cards to select an Oddity.

9. A game according to claim 1 further comprising:
As each player rolls in 1st 2nd 3rd 4th each will be given mileage points based on their roll in position, where the 1st will obtain set miles they each will get additional mileage based on increments of the set miles per position roll in 2nd will obtain more than the set miles and so on, where the players will take their mileage of their tally which will be on or over their mileage on the oddity card, they will take which ever mileage is greater the tally or the oddity and subtract, then the players will add in their given obtained mileage of roll in position and add that to that number to get their final mileage number.
